(19) United States
(12) Patent Application Publication
(10) Pub. No.: US 2026/0139726 A1
(43) Pub. Date: May 21, 2026

(54) VIBRATION ISOLATION SYSTEM

(71) Applicant: VERTIV CORPORATION, Westerville, OH (US)

(72) Inventor: Shridhar Jaywant PATIL, Kolhapur (IN)

(73) Assignee: VERTIV CORPORATION, Westerville, OH (US)

(21) Appl. No.: 19/390,195

(22) Filed: Nov. 14, 2025

(30) Foreign Application Priority Data
Nov. 15, 2024 (IN) 202421088512

(51) Int. Cl. F16F 15/04

(52) U.S. Cl. CPC F16F 15/04; F16F 2230/0005

(57) ABSTRACT

The present invention relates to a vibration isolation system for isolating vibrations from transmitting to a cabinet. The system comprises a bottom frame configured to be mounted on a rigid surface, the bottom frame having a bottom surface and side surfaces extending vertically therefrom. A top frame is configured to support the cabinet. The top frame is movably mounted on the bottom frame. A plurality of primary resilient members is positioned between ledges of the top frame and the side surfaces of the bottom frame. A plurality of secondary resilient members are positioned between an operating surface of a mounting base of the top frame and the bottom surface of the bottom frame.

### CROSS REFERENCE TO RELATED APPLICATION

This application claims priority under 35 USC 119 to Indian Provisional Patent Application No. 202421088512 entitled “A VIBRATION ISOLATION SYSTEM” filed Nov. 15, 2024, the disclosure of which is hereby expressly incorporated by reference in its entirety.

### TECHNICAL FIELD

The present disclosure relates to vibration isolation systems. More specifically, the present disclosure concerns a vibration isolation mechanism designed to mitigate the effects of seismic and other vibrational forces on mounted structures.

### BACKGROUND

Typically, cabinets are employed to house and secure various types of electrical equipment and machinery. These equipment and machines are electrically and functionally interconnected through one or more cables and adapters. In conventional configuration, the cabinets are usually floor-mounted on a plinth, which serves as a supportive base and creates space for routing cables and wiring underneath. Cabinet stability provides a foundational support for optimal equipment performance.

However, substantial vibrations are produced during turbulent events such as seismic activity, heavy construction, or demolition. Since the conventional cabinets are mounted directly on the ground, without any foundational support, vibrations transfer directly from the ground to the cabinet, causing unwanted movement of the cabinet during these turbulent events. This unwanted movement displaces both the equipment and the electrical connections, potentially resulting in damage or equipment failure.

Further, the conventional plinth configuration generally relies on rigid connections and reinforcements to withstand seismic forces. Although this configuration may provide a certain degree of stability, it often requires significant material use, raising the overall production cost of the cabinet.

Therefore, there is a need for a vibration isolation system for cabinets and enclosures that alleviates the aforementioned drawbacks.

### SUMMARY OF THE INVENTION

The present invention relates to a vibration isolation system for isolating vibrations, and minimizing the portion of isolated vibrations transmitted to a cabinet. The system comprises a bottom frame configured to be mounted on a rigid surface. The bottom frame having a bottom surface and side surfaces extending vertically therefrom. A top frame is configured to support the cabinet. The top frame comprises a mounting base and ledges extending outwardly from the mounting base. The top frame is movably mounted on the bottom frame. A plurality of primary resilient members is positioned between the ledges of the top frame and the side surfaces of the bottom frame. The primary resilient members are configured to restrict lateral movement of the top frame within the bottom frame. A plurality of secondary resilient members is positioned between an operating surface of the mounting base of the top frame and the bottom surface of the bottom frame. The secondary resilient members are configured to restrict vertical movement of the top frame relative to the bottom frame. The primary resilient members and the secondary resilient members are collectively configured to absorb vibrational forces in both lateral and vertical directions, thereby isolating the cabinet from external vibrations transmitted through the bottom frame.

In one aspect, the bottom frame is a box-shaped structure comprising a C-shaped pocket and an opening. The opening is configured to receive the top frame such that the ledges of the top frame are positioned within the pocket.

In one aspect, the primary resilient members are arranged in a spaced manner along the inner surfaces of the side surfaces of the bottom frame. Each of the primary resilient members having one end coupled to the ledges and an opposite end abutting the inner surface of the side surfaces of the bottom frame.

In one aspect, the secondary resilient members are arranged in a grid pattern on the bottom surface of the bottom frame. Each of the secondary resilient members have one end coupled to the operative surface of the mounting base of the top frame and an opposite end abutting the bottom surface of the bottom frame.

In one aspect, the bottom frame includes a plurality of fasteners configured to secure the bottom frame to the rigid surface. The fasteners are capable of withstanding oscillating forces acting on the bottom frame.

In one aspect, each of the primary resilient members and each of the secondary resilient members has stiffness level, configured to collectively absorb vibrations in multi-directional axes without compromising the stability of the top frame and the cabinet.

In one aspect, the top frame is dimensioned to allow lateral displacement within a predefined tolerance range inside the bottom frame, to provide controlled flexibility to absorb lateral and vertical vibrations.

In one embodiment, a method for isolating vibrations from transmitting to a cabinet mounted on a vibration isolation system is described. The method includes providing a bottom frame and mounting the bottom frame on a rigid surface. The bottom frame has a bottom surface and side surfaces extend vertically therefrom. The method further includes positioning a top frame within the bottom frame. The top frame comprises a mounting base and ledges extending outwardly from the mounting base. The method further includes mounting a plurality of primary resilient members between the ledges of the top frame and the side surfaces of the bottom frame. The primary resilient members restrict lateral movement of the top frame relative to the bottom frame. The method further includes mounting a plurality of secondary resilient members between the mounting base of the top frame and the bottom surface of the bottom frame. The secondary resilient members restrict vertical movement of the top frame relative to the bottom frame. The method further includes securing the cabinet on the mounting base of said the top frame. The method further includes absorbing vibrations through the primary resilient members and the secondary resilient members. The primary resilient members absorb lateral vibrations and the secondary resilient members absorb vertical vibrations, thereby isolating the cabinet from external vibrations.

In one aspect, the method further includes securing the bottom frame to the rigid surface using a plurality of fasteners capable of withstanding oscillating forces.

In one aspect, the method further comprises providing the bottom frame includes forming the bottom frame as a box-shaped structure with a C-shaped pocket to receive the top frame. Positioning the top frame within the bottom frame includes inserting the ledges of the top frame within the C-shaped pocket.

In one aspect, mounting the primary resilient members includes arranging the primary resilient members in a spaced manner along the inner surfaces of the side surfaces of the bottom frame. Each of the primary resilient members having one end coupled to the ledges and an opposite end abutting the side surfaces of the bottom frame.

In one aspect, mounting the secondary resilient members includes arranging the secondary resilient members in a grid pattern on the bottom surface of the bottom frame. Each of the secondary resilient members has one end coupled to the mounting base of the top frame and an opposite end abutting the bottom surface of the bottom frame.

In one aspect, the method further includes providing a tolerance between the ledges and the side surfaces of the bottom frame.

In one aspect, the method further includes selecting the stiffness levels of the primary resilient members and the secondary resilient members, enabling the resilient members to dampen multi-directional vibrations.

### BRIEF DESCRIPTION OF THE DRAWINGS

The accompanying figures of the drawing, which are included to provide a further understanding of general aspects of the system/method, are incorporated in and constitute a part of this specification. These illustrative aspects of the system/method, and together with the detailed description, explain the principles of the system. No attempt is made to show structural details in more detail than is necessary for a fundamental understanding of the system and various ways in which it is practiced. The following figures of the drawing include:

FIG. 1 illustrates an exploded view of the vibration isolation system for a cabinet, in accordance with one embodiment of the present disclosure;

FIG. 2 illustrates a vibration isolation system, in accordance with one embodiment of the present disclosure;

FIG. 3 illustrates a sectional front view of the vibration isolation system of FIG. 2, in accordance with one embodiment of the present disclosure;

FIG. 4 illustrates a top sectional view of the vibration isolation system of FIG. 2, in accordance with one embodiment of the present disclosure;

FIG. 5 illustrates the isometric view of the bottom frame, in accordance with one embodiment of the present disclosure;

FIG. 6A1-6C2 collectively illustrate the displacement of the vibration isolation system along sideways (X-axis) direction loading to mitigate the transmission of vibration, in accordance with one embodiment of the present disclosure;

FIG. 7A1-7C2 collectively illustrate the displacement of the vibration isolation system in front-to-back (Z-axis) direction loading to mitigate the transmission of vibration, in accordance with one embodiment of the present disclosure; and

FIGS. 8A and 8B illustrate the displacement of the vibration isolation system as claimed in the present disclosure operating in vertical (Y-axis) direction loading to mitigate the transmission of vibration, in accordance with one embodiment of the present disclosure.

### DESCRIPTION OF THE INVENTION

The present disclosure relates to vibration isolation systems. More specifically, the present disclosure concerns a vibration isolation mechanism designed to mitigate the effects of seismic and other vibrational forces on mounted structures.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, elements, modules, units and/or components, but do not forbid the presence or addition of one or more other features, elements, components, and/or groups thereof.

The term ‘plinth’ herein refers to a structural base or platform used to support and stabilize an enclosure housing an object or equipment, such as a cabinet. Typically positioned on the floor, the plinth provides stability to the equipment and elevates the equipment creating space underneath the equipment for cables, wiring, or other components.

In industrial and commercial settings, the stability and resilience of mounted equipment, such as cabinets and enclosures, are essential for safety and performance, particularly in regions where seismic activity is a concern. Equipment mounted in such areas is vulnerable to seismic forces, which may cause substantial displacement and potentially lead to structural failure or malfunctions. To address these risks, cabinets and other structures are commonly mounted on a plinth a structural base that serves as both a stabilizing platform and a means of elevating the equipment, providing space for cables, wiring, or ventilation.

Traditional plinth designs often rely on rigid connections and reinforced materials to withstand seismic forces. Traditional designs may provide stability to a certain degree but typically require substantial material use to meet seismic performance standards, which drives up production costs. Furthermore, these designs do not fully isolate the cabinet from seismic vibrations and movements. When seismic forces act on the ground, they may still cause a degree of displacement that is transferred up through the plinth and into the cabinet. This displacement may impact sensitive components within the cabinet and potentially lead to equipment damage, especially during high-intensity seismic events.

Seismic forces are complex in nature and typically involve multidirectional movements, including side-to-side (X-axis), front-to-back (Z-axis), and top-to-bottom (Y-axis) shifts. Consequently, there exists a need for a vibration isolation system that may alleviate the aforementioned drawbacks without compromising stability.

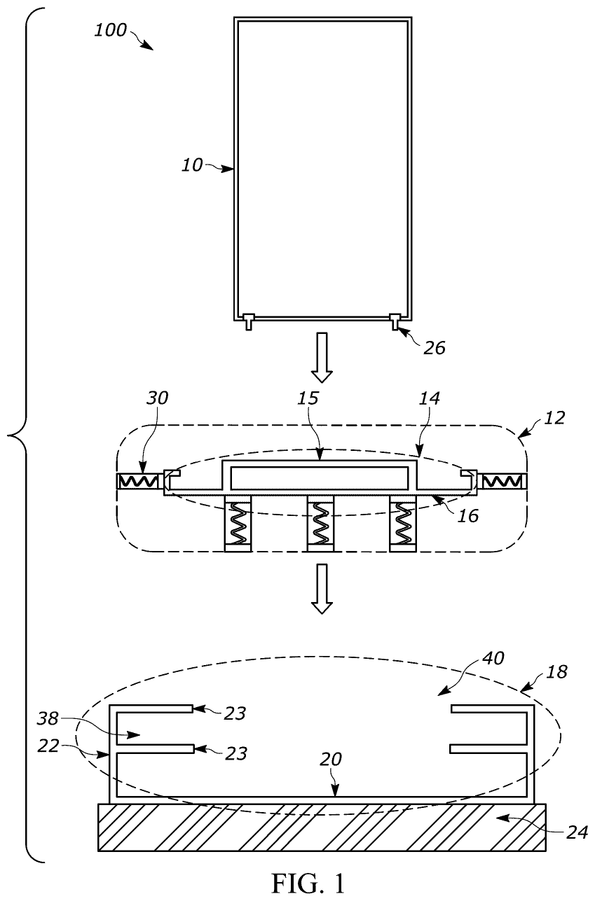

Embodiments of the present disclosure will now be described with reference to FIG. 1 through FIG. 8.

The present disclosure addresses these challenges by introducing a vibration isolation system (100). The vibration isolation system (100) may be configured to mitigate the transmission of vibrations to equipment and machinery enclosed within a cabinet (10). As best illustrated in FIG. 1 the vibration isolation system (100) may utilize a dual-frame structure, comprising a top frame (12), which may serve as the mounting platform for the cabinet (10), and a bottom frame (18), which may be securely mounted to a mounting surface, a floor or another rigid surface (24).

In an embodiment, the top frame (12) may be movably mounted on an operative surface of the bottom frame (18), allowing controlled movement in response to external forces.

The bottom frame (18) illustrated in FIG. 1, may be defined by a box-shaped structure, which may include a bottom surface (20), vertically extending side surfaces (22), and a pair of flanges (23). The pair of flanges (23) may partially extend orthogonally from the side surfaces (22) to form a C-shaped pocket (38) and an opening (40). The cabinet (10) may be affixed to the top frame (12) via one or more fasteners (26). The bottom surface (20) may be secured to the rigid surface (24) through cementing or a securing mechanism.

The securing mechanism may be configured to withstand oscillating forces generated by the turbulent events and prevent any displacement of the bottom frame (18) relative to the ground or mounting surface.

The bottom frame (18) may be shaped, depending upon the specific application needs, in various structural configurations, such as a square box, or a rectangular box structure, and the like.

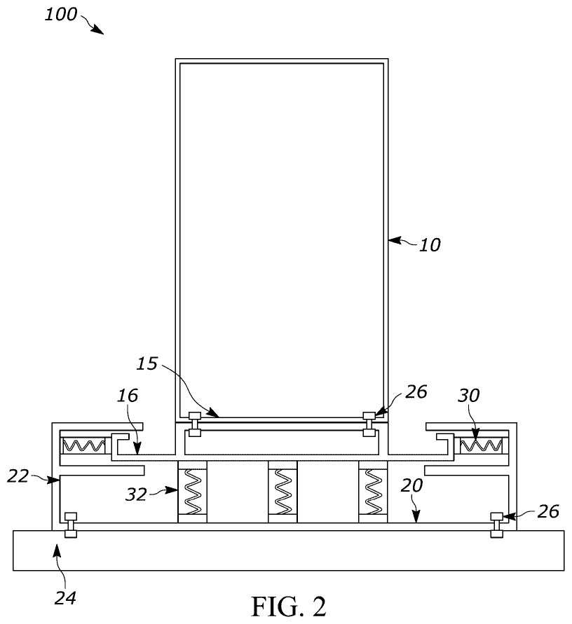

Within the system (100), as illustrated in FIG. 1, the top frame (12) may incorporate a plinth (14), a plurality of primary resilient members (30), and secondary resilient members (32) (see,. e.g., FIG. 2) each of which may serve specialized damping functions. Turning back to FIG. 1, the plinth (14) may be structured with a mounting base (15) and a ledge (16) that may extend parallel to the edges of the mounting base (15) in an outward direction. The ledge (16) may surround the mounting base (15), with one end of each primary resilient member (30) secured to an operative surface of the ledge (14), while an operative bottom surface of the mounting base (15) may secure one end of each secondary resilient member (32).

To enhance stability, the ledge (16) may surround the mounting base (15) on all operative sides, allowing each side of the ledge (16) to accommodate at least two, primary resilient members (30). Thus, the mounting base (15) may hold a total of at least eight primary resilient members (30). Additionally, the bottom surface of the mounting base (15) may be fitted with at least four secondary resilient members (32), depending on vibration control requirements.

The bottom surface of the mounting base (15) may be fitted with at least three or four secondary resilient members (32). Shape of the mounting base (15) may be complementary to the opening (40) configured on the bottom frame (18) to ensure a snug fit.

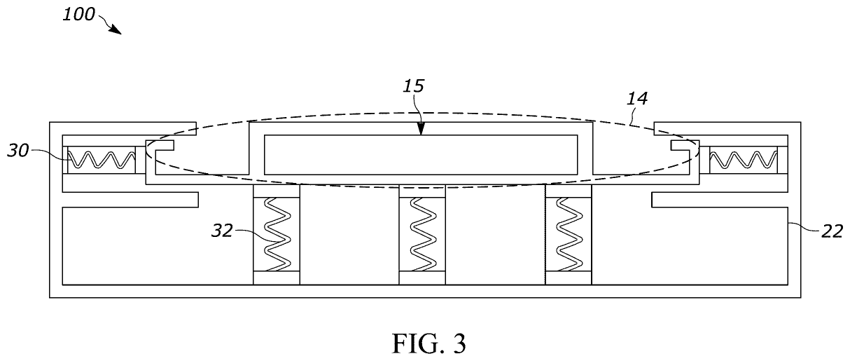

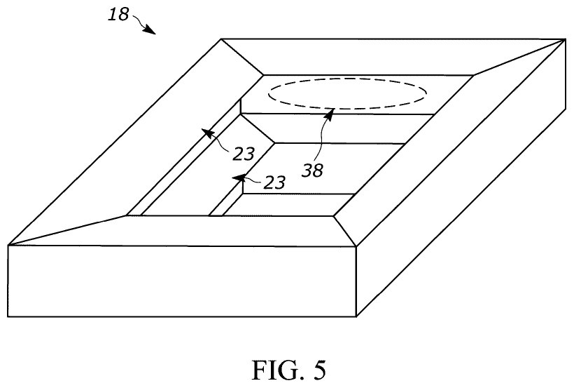

Further, in an operative configuration of the proposed system (100) as shown in FIG. 3,, the top frame (12) may be positioned within the bottom frame (18) so that the ledge (16) resides within the C-shaped pocket (38) (see, e.g., FIGS. 1 and 5), with the opposite ends of the primary resilient members (30) abutting the inner surfaces of the side surfaces (22) within the pocket (38). The other ends of the secondary resilient members (32) may compressibly rest against the bottom surface (20) of the bottom frame (18). This setup may enable the cabinet (10) to be securely mounted on the top surface (12) of the mounting base (15) with additional fasteners (26).

Together, the primary resilient members (30) may restrict lateral movement of the top frame (12), while the secondary resilient members (32) may limit upward and downward motion of the top frame (12). The coordinated action between the primary and secondary resilient members (30, 32) may absorb the impact of the undesirable vibrations minimizing the chances of transferring the undesirable vibrations to the sensitive equipment situated within the cabinet (10).

In an embodiment, the recess of the C-shaped pocket (38) and the vertical displacement space within the isolation system (100) may provide sufficient clearance for the lateral displacement of the top frame (12), thereby preventing the friction caused by the metal-to-metal contact. In addition, the primary resilient members (30) and secondary resilient members (32) may be optimized to dampen both horizontal and vertical vibrations, respectively.

Stiffness of the primary resilient members (30) may be identical as that of the secondary resilient members (32). The stiffness of the primary resilient members (30) may be different from that of the secondary resilient members (32). The stiffness of the primary resilient members (30) and the secondary resilient members (32) may be dependent on the intensity of horizontal and vertical vibrational waves as well as the gross weight of the cabinet (10).

The configuration may also incorporate a tolerance allowance between the ledges (16) of the plinth (14) and the side surfaces (22) of the bottom frame (18). This configuration may provide marginal tolerance for the primary resilient members (30) to facilitate a degree of horizontal motion for the plinth (14) relative to the bottom frame (18), while the secondary resilient members (32) may control vertical motion within a defined range, preventing excessive movement. The tolerance provided may enable the relative motion of the top frame (12) without compromising the stability of the cabinet (10) positioned above the top frame (12).

Advantageously, the disclosed embodiment of the vibration isolation system (100) addresses both vertical and horizontal oscillations by actively decoupling the cabinet (10) from ground-transmitted vibrations through a multi-directional damping configuration. Thus, the system (100) may remain stable across multiple axes even when subjected to high turbulence. A defined ground motion (34) may signify the direction of oscillation, while a neutral state (36) may indicate the system's balanced position.

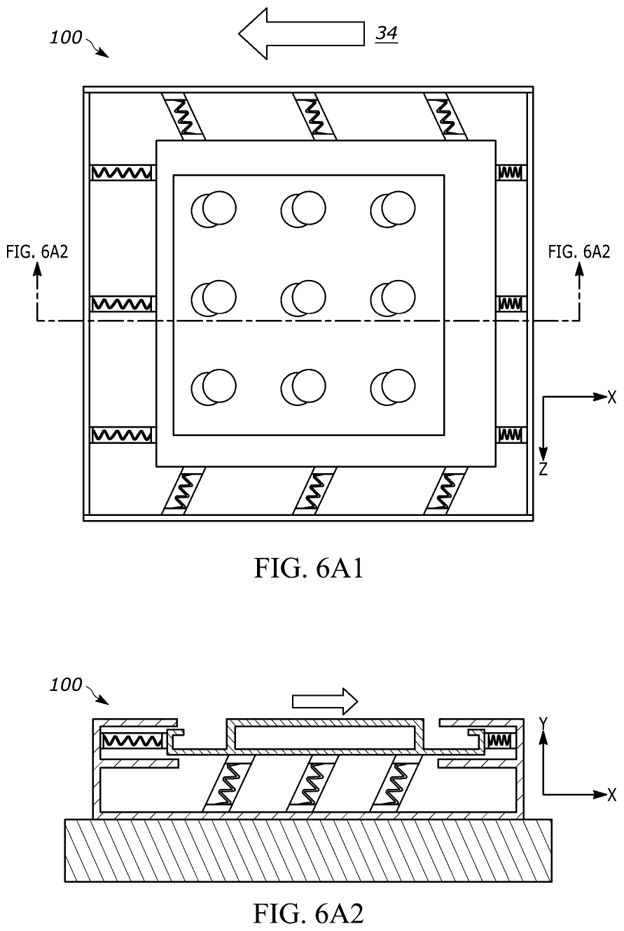

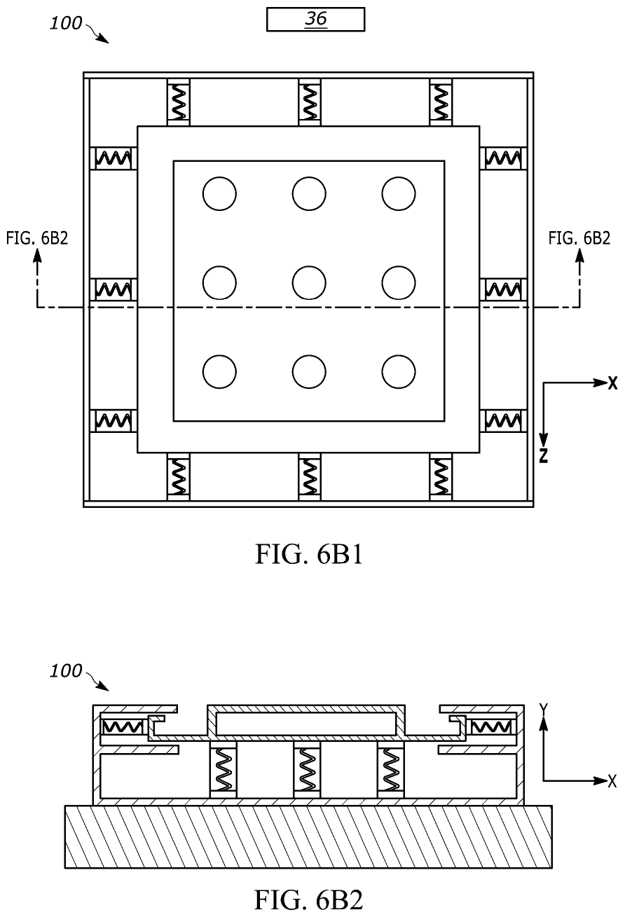

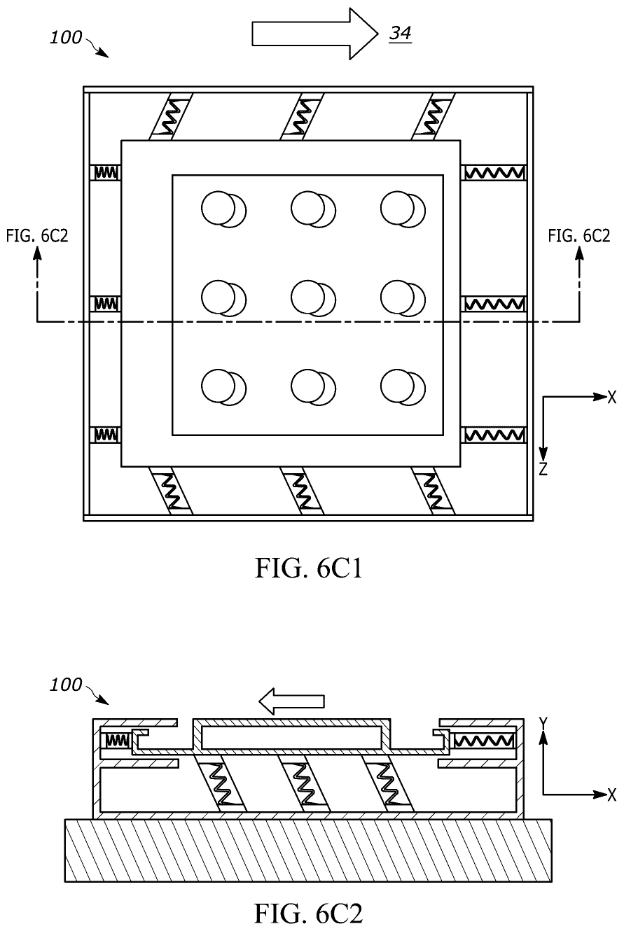

When vibrational forces impact the rigid surface (24), these forces propagate upward toward the bottom frame (18), which is securely mounted to the rigid surface (24) via securing mechanism. Upon reaching the bottom surface (20) of the bottom frame (18), the vibrational forces encounter the secondary resilient members (32) attached to the bottom surface (20). As depicted in FIGS. 6 to 8, the secondary resilient members (32) are configured to counteract vertical vibrations by compressing and expanding in response to upward or downward movements. These secondary resilient members (32) absorb the vertical component of the vibrational energy, dissipating it through compression and expansion, thereby minimizing the direct transmission of force to the plinth (14) and the cabinet (10).

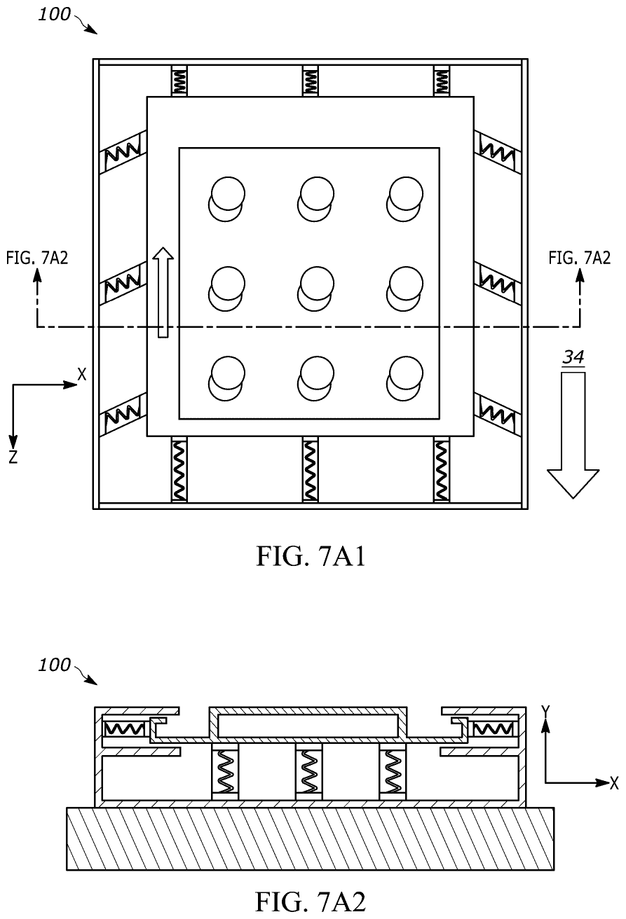

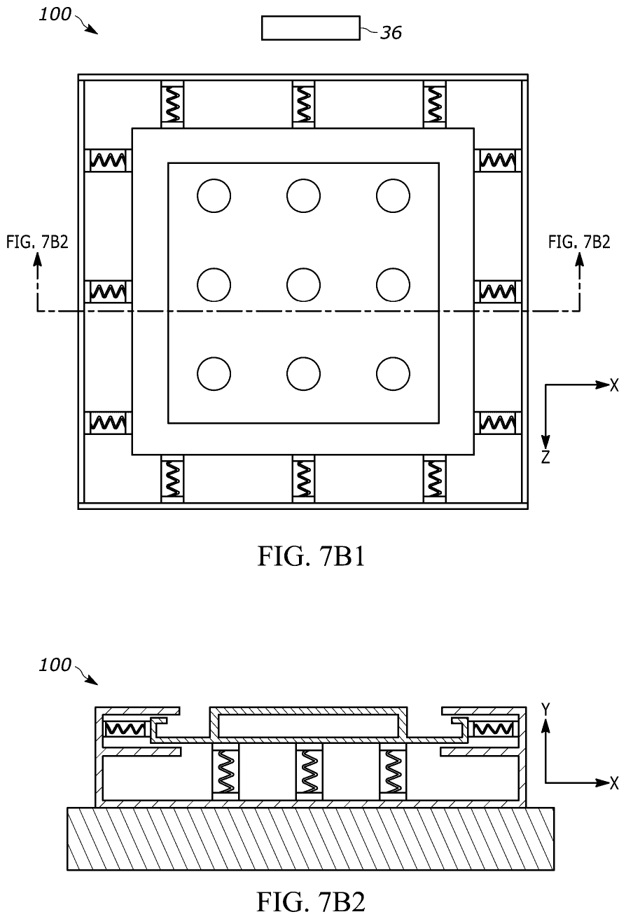

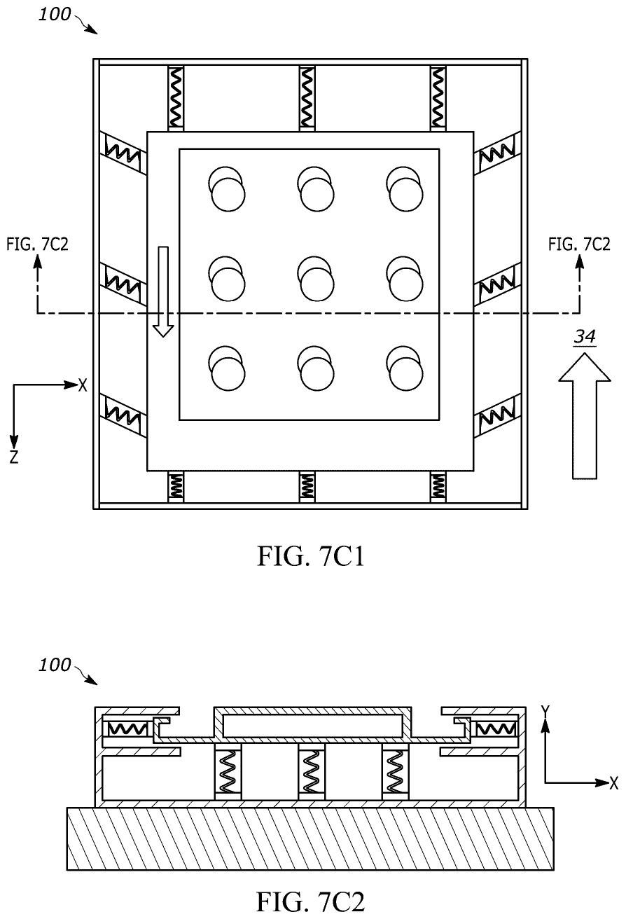

Simultaneously, the primary resilient members (30) are positioned along the inner lateral surfaces of the side walls of the top frame (12). As shown in FIG. 6A1-6C2, the primary resilient members (30) are strategically located to address horizontal vibrations. When a lateral force arises, whether due to seismic activity or industrial machinery vibrations, the primary resilient members (30) absorb the energy by flexing horizontally. This lateral damping mechanism effectively minimizes, if not completely stops, transmission of vibrational energy to the cabinet (10), further stabilizing the system (100). Specifically, FIGS. 6A and 6C illustrate vibration damping along the X-axis (side-to-side), while FIGS. 7A and 7C show vibration damping along the Z-axis (front-to-back).

FIGS. 6A1 and 6A2 collectively illustrate the sideways displacement (i.e., along the X-axis) of the vibration isolation system. As shown in FIGS. 6A1 and 6A2, the vibration isolation system 100 is in a state of leftward ground motion (34) causing the primary resilient members (30) and secondary resilient members (32) to be displaced to the right-side of the system to mitigate the transmission of vibration caused by the leftward ground motion (34). It is observed that while responding to the leftward ground motion (34), the degree of compression of the primary compression member 30 located on the right side of the plinth 14 is greater than the degree of compression of the primary compression member 30 located on the left side of the plinth 14.

FIGS. 6C1 and 6C2 collectively illustrate the sideways displacement (i.e., along the X-axis) of the vibration isolation system. As shown in FIGS. 6C1 and 6C2, the vibration isolation system 100 is in a state of rightward ground motion (34) causing the primary resilient members (30) and secondary resilient members (32) to be displaced to the left-side of the system to mitigate the transmission of vibration caused by the rightward ground motion (34). Responding to the rightward ground motion (34), the degree of compression of the primary compression member 30 located on the left side of the plinth 14 is greater than the degree of compression of the primary compression member 30 located on the right side of the plinth 14. In contrast to FIGS. 6A and 6C, the vibration isolation system 100 in FIG. 6B1 and 6B2 collectively illustrate a neutral state (36) indicating that the vibration isolation system is in a balanced position.

FIGS. 7A1 and 7A2 collectively illustrate the forward displacement (i.e., along the Z-axis) of the vibration isolation system. As shown in FIGS. 7A1 and 7A2, the vibration isolation system 100 is in a state of forward ground motion (34) causing the primary resilient members (30) and second resilient members (32) to be displaced rearward to mitigate the transmission of ground energy pushing forward on the system. On the other hand, the vibration isolation system 100 is in a state of rearward ground motion (34) in FIGS. 7C1 and 7C2 causing the primary resilient members (30) and second resilient members (32) to be displaced forward (along the Z-axis) to mitigate the transmission of ground energy pushing rearward on the system. In contrast to FIGS. 7A and 7C, the vibration isolation system 100 in FIGS. 7B1 and 7B2 collectively illustrate a neutral state (36) indicating that the vibration isolation system is in a balanced position.

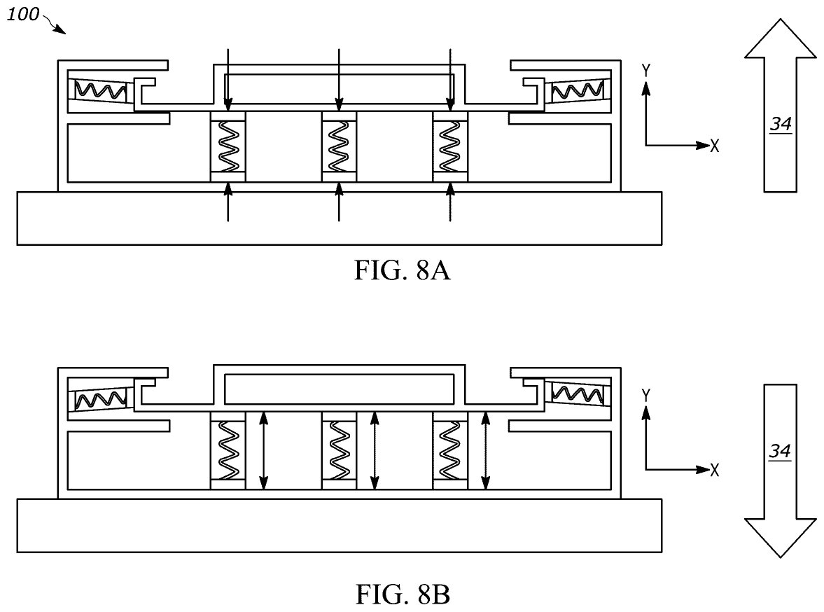

FIG. 8A illustrates the vertical displacement (i.e., along the Y-axis) of the vibration isolation system. As shown in FIG. 8A, the vibration isolation system 100 is in a state of upward ground motion (34) causing primarily the second resilient members (32) to be compressed to mitigate the transmission of upward ground energy (i.e., vibration). On the other hand, the vibration isolation system 100 illustrated in FIG. 8B is in a state of downward ground motion (34) causing primarily the second resilient members (32) to resist expansion (i.e., along the Y-axis) to mitigate the transmission of vibration.

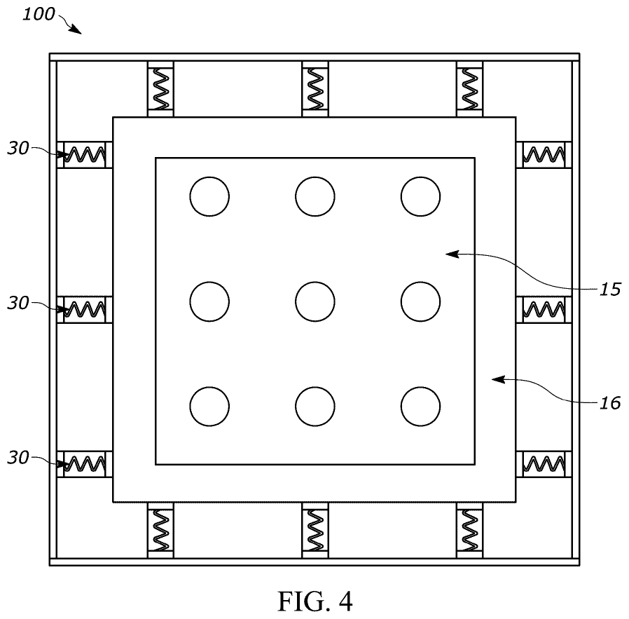

As shown in FIG. 4, the resilient members (30, 32) absorb the vibrational energy, the plinth (14), mounted on the primary and secondary resilient members (30, 32), remains relatively stationary. The plinth (14) is configured to “float” on the resilient members (30, 32), allowing the plinth (14) to displace slightly within a controlled range in response to incoming vibrational forces without compromising the stability of the cabinet (10). The laterally extending ledges (16) of the plinth (14), connected to the primary resilient members (30), facilitate limited horizontal movement, while the secondary resilient members (32) below permit controlled vertical motion. This flexibility of the plinth (14) across x, y and z axis is helpful in isolating the cabinet (10) from both vertical, lateral shift and frontal shifts.

In practical operation, the plinth (14) is subjected to both vertical forces and horizontal forces. The vertical forces are applied along the y axis causing up-down movement, while the horizontal forces are applied along the x axis and the z axis, causing side-to-side movement and front-to-back movement respectively. When the vertical forces and the horizontal forces act simultaneously, the primary and secondary resilient members (30, 32) work in tandem. For instance, if an upward shock is accompanied by a sideways shift, the secondary resilient members (32) compress to absorb the vertical impact, while the primary resilient members (30) flex to counter the horizontal motion. The combination of these responses minimizes the turbulent impact on the cabinet (10) positioned above the plinth (14).

The vibration isolation system (100) may be particularly effective in environments prone to sustained or high-impact vibrations. The passive configuration of the resilient members (30, 32) may allow the system (100) to react nearly instantaneously to absorb oscillations caused by external force, without the need for external controls or adjustments. Furthermore, the damping properties of the resilient members (30, 32) may prevent (or at least minimize) additional resonant vibrations from developing, which could otherwise amplify and worsen the vibration impact on the cabinet (10). In scenarios where repeated or sustained vibrational loads occur, the resilient members (30, 32) iteratively undergo controlled compression and relaxation cycles. Made from material providing elasticity the resilient members (30, 32) have the ability to return to their original positions once the vibrational forces subside, ready to respond to the next instance of vibration. Over time, this adaptive mechanism maintains the system's effectiveness without excessive wear, which may provide long-term protection for the cabinet (10).

The present disclosure described hereinabove has several technical advantages including, but not limited to, the vibration isolation system that:
may effectively absorb and dissipate vibrations generated by seismic events, construction, or demolition activities by minimizing direct vibration transfer to the cabinet, and safeguarding both the equipment and electrical connections;
may ensure stability under high-vibration conditions;
may minimize unnecessary material costs while maintaining the durability and strength needed for high-performance applications;
may allow equipment within the cabinet to remain connected and secure despite external vibrations; and
may allow quick adjustments or repairs, to reduce the downtime and improve the serviceability.

The foregoing disclosure has been described with reference to the accompanying embodiments which do not limit the scope and ambit of the disclosure. The description provided is purely by way of example and illustration.

What is claimed is:

1. A vibration isolation system for minimizing transmission of vibrations to a cabinet, the system comprising:
a bottom frame configured to be mounted on a rigid surface, the bottom frame having a bottom surface and side surfaces wherein the side surfaces extend vertically from the bottom surface;
a top frame configured to support the cabinet, the top frame comprising a mounting base and ledges extending outwardly from the mounting base, wherein the top frame is movably mounted on the top surface of the bottom frame;
a plurality of primary resilient members positioned between the ledges of the top frame and the side surfaces of the bottom frame, the plurality of primary resilient members configured to restrict lateral movement of the top frame within the bottom frame; and
a plurality of secondary resilient members positioned between an operating surface of the mounting base of the top frame and the bottom surface of the bottom frame, the secondary resilient members configured to restrict vertical movement of the top frame relative to the bottom frame,
wherein the primary resilient members and the secondary resilient members are collectively configured to absorb vibrational forces generated along any and all of the x-axis, y-axis and z-axis, thereby isolating the cabinet from external vibrations transmitted through the bottom frame.

2. The system of claim 1, wherein the bottom frame is a box-shaped structure comprising a C-shaped pocket and an opening, the opening (40) being configured to receive the top frame such that the ledges of the top frame are positioned within the C-shaped pocket.

3. The system of claim 1, wherein the primary resilient members are arranged in a spaced manner along the inner surfaces of the side surfaces of the bottom frame, each of the primary resilient members having one end coupled to the ledges and an opposite end abutting the inner surface of the side surfaces of the bottom frame.

4. The system of claim 1, wherein the secondary resilient members are arranged in a grid pattern on the bottom surface of the bottom frame, wherein one end of each secondary resilient member is coupled to the operative surface of the mounting base of the top frame and the opposite end abutting the bottom surface of the bottom frame.

5. The system of claim 1, wherein the bottom frame includes a plurality of fasteners configured to secure the bottom frame to the rigid surface, wherein the fasteners are configured to withstand oscillating forces acting on the bottom frame.

6. The system of claim 1, wherein each of the primary resilient members and each of the secondary resilient members has stiffness level, configured to collectively absorb vibrations from multi-directional axes without compromising the stability of the cabinet.

7. The system of claim 1, wherein the top frame is dimensioned to allow lateral displacement within a predefined tolerance range inside the bottom frame, to provide controlled flexibility to absorb lateral and vertical vibrations.

8. A method for isolating vibrations from transmitting to a cabinet mounted on a vibration isolation system, the method comprising the following steps:
providing a bottom frame and mounting the bottom frame on a rigid surface, the bottom frame having a bottom surface and side surfaces extending vertically therefrom;
positioning a top frame within the bottom frame, the top frame comprising a mounting base and ledges extending outwardly from the mounting base;
mounting a plurality of primary resilient members between the ledges of the top frame and the side surfaces of the bottom frame, wherein the primary resilient members restrict lateral movement of the top frame relative to the bottom frame;
mounting a plurality of secondary resilient members between the mounting base of the top frame and the bottom surface of the bottom frame, wherein the secondary resilient members restricts vertical movement of the top frame relative to the bottom frame;
securing the cabinet on the mounting base of the top frame; and
absorbing vibrations through the primary resilient members and the secondary resilient members, wherein the primary resilient members absorb lateral vibrations and the secondary resilient members absorb vertical vibrations, thereby isolating the cabinet from external vibrations.

9. The method of claim 8, includes securing the bottom frame to the rigid surface using a plurality of fasteners capable of withstanding oscillating forces.

10. The method of claim 8, wherein providing the bottom frame includes forming the bottom frame as a box-shaped structure with a C-shaped pocket to receive the top frame, and wherein positioning the top frame within the bottom frame includes inserting the ledges of the top frame within the C-shaped pocket.

11. The method of claim 8, wherein mounting the primary resilient members includes arranging the primary resilient members in a spaced manner along the inner surfaces of the side surfaces of the bottom frame, each of the primary resilient member having one end coupled to the ledges and an opposite end abutting the side surfaces of the bottom frame.

12. The method of claim 8, wherein mounting the secondary resilient members includes arranging the secondary resilient members in a grid pattern on the bottom surface of the bottom frame, each of the secondary resilient members having one end coupled to the mounting base of the top frame and an opposite end abutting the bottom surface of the bottom frame.

13. The method of claim 8, includes providing a tolerance between the ledges and the side surfaces of the bottom frame.

14. The method of claim 8, includes selecting the stiffness levels of the primary resilient members and the secondary resilient members, enabling the resilient members to dampen multi-directional vibrations.
